(19) United States
(12) Patent Application Publication
(10) Pub. No.: US 2026/0245419 A1
(43) Pub. Date: Aug. 20, 2026

(54) MONEY STORAGE DEVICE, MONEY HANDLING DEVICE, AND MONEY STORAGE METHOD

(71) Applicant: GLORY LTD., Himeji-shi (JP)

(72) Inventors: Hidetomo YANAGIUCHI, Himeji-shi (JP); Michihiro YASUI, Himeji-shi (JP); Kazuki SHIBATA, Himeji-shi (JP); Eiki YAMAMOTO, Himeji-shi (JP); Kenta ISHINO, Himeji-shi (JP); Yuya MURAGISHI, Himeji-shi (JP)

(73) Assignee: GLORY LTD., Himeji-shi (JP)

(21) Appl. No.: 19/537,576

(22) Filed: Feb. 12, 2026

(30) Foreign Application Priority Data
Feb. 17, 2025 (JP) 2025-023387

(51) Int. Cl. G07D 11/12; B65H 29/00; G07D 11/16; G07D 11/23

(52) U.S. Cl. CPC G07D 11/12; B65H 29/00; G07D 11/16; G07D 11/23; B65H 2301/42266; B65H 2404/733; G07D 2211/00

(57) ABSTRACT

A money storage device includes a pair of plates having accumulation surfaces on which banknotes are accumulated in a support posture in which the pair of plates is arranged in a first direction, and a pusher that pushes the banknotes accumulated on the accumulation surfaces in a second direction crossing the first direction, to store the banknotes in a storage bag. The pair of plates changes from the support posture to a passage posture. The banknotes pushed by the pusher is guided by the accumulation surfaces of the pair of plates in the passage posture while passing between the pair of plates, and is stored in the storage bag.

### CROSS-REFERENCE TO RELATED APPLICATION

This application claims priority to Japanese Patent Application No. 2025-023387 filed on Feb. 17, 2025, the entire disclosure of which is incorporated by reference herein.

### BACKGROUND

A conventional banknote storage device stores a banknote in a disposable storage bag. The conventional banknote storage device includes a container that temporarily houses the banknote, and a piston that pushes out the banknote housed in the container toward the bottom of the container.

The bottom of the container is provided with an opening. The opening is significantly narrower than the width of the banknote. The banknote does not pass through the opening as long as the banknote is not pushed by the piston, and therefore, is accumulated on the bottom of the container.

The storage bag is fixed near the opening of the bottom of the container. When the piston pushes down the banknotes in a state of the banknotes being accumulated on the bottom of the container, the bundle of the banknotes is pushed by the piston, passes through the opening, and is stored in the storage bag.

### SUMMARY

The technique disclosed herein relates to a money storage device. The money storage device includes
a pair of plates having accumulation surfaces on which banknotes are accumulated in a support posture in which the pair of plates is arranged in a first direction, and
a pusher that pushes the banknotes accumulated on the accumulation surfaces in a second direction crossing the first direction, to store the banknotes in a storage bag,
the pair of plates changes from the support posture to a passage posture, and
the banknotes pushed by the pusher is guided by the accumulation surfaces of the pair of plates in the passage posture while passing between the pair of plates, and is stored in the storage bag.

### BRIEF DESCRIPTION OF THE DRAWINGS

FIG. 1 shows the appearance of a banknote handling device.

FIG. 2 shows an internal structure of the banknote handling device.

FIG. 3 shows a storage bag.

FIG. 4 is a plan view and a side view of a banknote storage device.

FIG. 5 is a plan view of the banknote storage device in a state of a bag opening of the storage bag being opened, and a sectional view thereof taken along line A-A.

FIG. 6 shows an improper attachment state of the storage bag.

FIG. 7 shows an improper attachment state of the storage bag.

FIG. 8 shows a correspondence between sensing of a sensor and an attachment state of the storage bag.

FIG. 9 is a side view of the banknote storage device.

FIG. 10 shows a movement mechanism of a stage.

FIG. 11 shows a drive mechanism of a pusher.

FIG. 12 is a transition view of an operation of storing banknotes in the storage bag.

FIG. 13 shows a modification of a plate.

FIG. 14 shows a correspondence between the position of the pusher and a sensing state of the sensor.

FIG. 15 is a flowchart showing steps of determining a full capacity.

FIG. 16 shows a state of the pusher being positioned at a standby position and a state of the pusher having performed a push-in operation.

FIG. 17 shows a state of arrival of the stage at the lowest position having been sensed and a state of arrival of a stack end at a full capacity position having been sensed.

FIG. 18 shows a state in which the stage reaches the lowest position and the pusher does not reach a maximum push-in position.

FIG. 19 shows a feeding mechanism of the storage bag.

FIG. 20 is a transition view of an operation of sealing the bag opening of the storage bag.

FIG. 21 shows a structure of holding an edge of the bag opening of the storage bag.

### DETAILED DESCRIPTION OF THE DRAWINGS

The conventional banknote storage device has a narrow width of the opening of the container. The number of banknotes which can be pushed by the piston and pass through the opening all at once is small. In a case where many banknotes are stored in the storage bag, the conventional banknote storage device needs to repeat many times accumulation of banknotes in the container and pushing out of the accumulated banknotes.

With a greater width of the opening of the container, the number of banknotes which can pass through the opening increases. However, if the width of the opening increases, the banknotes cannot be stably accumulated in the container.

According to the technique disclosed herein, a large number of banknotes are stored in the storage bag all at once.

The technique disclosed herein relates to a money storage device. The money storage device includes
a pair of plates having accumulation surfaces on which banknotes are accumulated in a support posture in which the pair of plates is arranged in a first direction, and
a pusher that pushes the banknotes accumulated on the accumulation surfaces in a second direction crossing the first direction, to store the banknotes in a storage bag,
the pair of plates changes from the support posture to a passage posture, and
the banknotes pushed by the pusher are guided by the accumulation surfaces of the pair of plates in the passage posture while passing between the pair of plates, and are stored in the storage bag.

When the banknotes are accumulated, the pair of plates is in the support posture. For example, by narrowing the interval between the plates arranged in the first direction, the banknotes can be stably accumulated on the pair of plates.

When the accumulated banknotes are stored in the storage bag by the pusher, the pair of plates changes to the passage posture. By the change to the passage posture, the interval between the plates increases so that a large number of banknotes can pass between the pair of plates all at once.

The pair of plates in the passage posture guides the banknotes along the accumulation surfaces. Even with a narrow bag opening of the storage bag, the banknotes pushed by the pusher is stably stored in the storage bag. The narrow bag opening of the storage bag is advantageous in reduction in the size of the money storage device.

Another money storage device disclosed herein includes
a pair of plates having accumulation surfaces on which banknotes are accumulated in a support posture in which the pair of plates is arranged in a first direction, and
a pusher that pushes the banknotes accumulated on the accumulation surfaces in a second direction crossing the first direction, to store the banknotes in a storage bag,
the banknotes pushed by the pusher pass between the pair of plates changed from the support posture to a passage posture, and are stored in the storage bag, and
an interval in the first direction between the pair of plates in the passage posture is narrower than the width of the banknote in the first direction.

Still another money storage device disclosed herein includes
a pair of plates having accumulation surfaces on which banknotes are accumulated in a support posture in which the pair of plates is arranged in a first direction, and
a pusher that pushes the banknotes accumulated on the accumulation surfaces in a second direction crossing the first direction, to store the banknotes in a storage bag,
the banknotes pushed by the pusher pass between the pair of plates displaced from the support posture to a passage posture, and are pushed into the storage bag,
each of the pair of plates is pivotally supported by a pivot shaft orthogonal to the first direction and the second direction, and turns in the second direction from the support posture to change to the passage posture, and
an interval between the pivot shafts is narrower than the width of the banknote in the first direction.

By turning the pair of plates pivotally supported by the pivot shafts, the interval between the pair of plates increases. The pusher and the pair of plates can store a large number of banknotes in the storage bag all at once.

The angle of each of the pair of plates in the passage posture with respect to that in the support posture may be 80° or less.

When the angle of the pair of plates exceeds 80°, the interval between the plate and the plate is excessive.

When the angle of the pair of plates is 80° or less, the interval between the plate and the plate is relatively great, but banknotes can pass between the pair of plates while the plates are guiding the banknotes.

The banknotes passing between the pair of plates may be sandwiched by the pusher and the pair of plates and be bent in the second direction.

By causing the bent banknotes to pass between the pair of plates, the banknotes are stably stored in the storage bag even if a bag opening of the storage bag is narrow.

The money storage device may further include a stage positioned on the opposite side of the pair of plates from the pusher and supporting the banknotes stored in the storage bag, and the stage may hold the banknotes between the stage and the pusher when the pusher pushes the banknotes.

Since the banknotes are held between the pusher and the stage, the money storage device can stably store the banknotes in the storage bag. Moreover, the banknotes are stably stacked in the storage bag.

The stage may move in the second direction between a first position at which the stage approaches the pair of plates and a second position at which the stage is apart from the pair of plates, according to the number of banknotes stored in the storage bag.

In a state of the storage bag being empty, the stage may be positioned at the first position, and may hold the banknotes to be first stored in the storage bag. As the banknotes stored in the storage bag increase, the stage may move from the first position toward the second position.

The money storage device may further include a movement mechanism that moves the stage, and
the movement mechanism may have a first base supporting the stage such that the stage is movable in the second direction and a second base supporting the first base such that the first base is movable in the second direction.

By moving each of the stage and the first base, the movement mechanism can increase the amount of movement of the stage with a compact structure.

The movement mechanism may have a belt supported by the first base and wound around a pair of pulleys,
the stage may be engaged with a first carriage fixed to the belt, and
the second base may be engaged with a second carriage fixed to the belt.

The money storage device may further include a controller that determines, based on a first full capacity criterion or a second full capacity criterion, the full capacity of the banknotes stored in the storage bag,
the first full capacity criterion may be that the number of banknotes stored in the storage bag reaches a full capacity number, and
the second full capacity criterion may be that the number of banknotes stored in the storage bag is less than the full capacity number and an end of the stack of the banknotes stacked in the storage bag reaches a full capacity position.

In a case where the banknotes stored in the storage bag are relatively-neat banknotes (for example, uncirculated banknotes), the volume of the banknotes stacked in the storage bag is a volume corresponding to the number of banknotes. In a case where the banknotes stored in the storage bag are, for example, wrinkled banknotes (so-called bulky banknotes) with many wrinkles, the banknotes stacked in the storage bag expand, and for this reason, are relatively bulkier than the volume corresponding to the number of banknotes.

A probability of the banknote being caught by the bag opening when the bag opening of the storage bag is sealed is higher in the case of the bulky banknotes. Thus, with reference to the bulky banknotes, the full capacity of the banknotes is set based on the position of the end of the stack of the banknotes stored in the storage bag, so that the probability of the banknote being caught by the bag opening can be decreased.

However, in a case where the relatively-neat banknotes are stored in the storage bag, even if a distance between the end of the stack of the banknotes and the bag opening of the storage bag is short to a certain extent, the probability of the banknote being caught by the bag opening is low. In the case of the relatively-neat banknotes, no interference with sealing of the storage bag is caused even if the full capacity of the banknotes is increased.

Thus, based on the first full capacity criterion or the second full capacity criterion, the money storage device determines the full capacity of the banknotes stored in the storage bag.

The first full capacity criterion is the criterion based on the number of banknotes stored in the storage bag. The first full capacity criterion is the criterion in a case where the relatively-neat banknotes are stored in the storage bag. According to the first full capacity criterion, the money storage device can store a larger number of banknotes in the storage bag.

The second full capacity criterion is the criterion in a case where the bulky banknotes are stored in the storage bag. The second full capacity criterion is the criterion based on the position of the end of the stack of the banknotes stacked in the storage bag. According to the second full capacity criterion, the money storage device can ensure a sufficiently-long distance between the end of the stack of the banknotes and the bag opening of the storage bag, and therefore, catching of the banknote by the bag opening at the time of sealing the storage bag is reduced.

The money storage device may further include a sensor that senses that the pusher performing a push-in operation reaches a maximum push-in position, and when the stage supporting the banknotes stored in the storage bag and displacing according to the number of banknotes reaches the lowest position and the sensor senses that the pusher reaches the maximum push-in position, the controller may determine, based on the first full capacity criterion or the second full capacity criterion, the full capacity of the banknotes stored in the storage bag.

When the pusher performs the push-in operation in a state of the bulky banknotes being stored in the storage bag, the stacked banknotes are compressed by the pusher. On the other hand, in a case where the relatively-neat banknotes are stored in the storage bag, even when the pusher performs the push-in operation, the stacked banknotes are not compressed much. Regardless of the state of the banknotes stored in the storage bag, as long as it is sensed that the stage reaches the lowest position and the pusher reaches the maximum push-in position, it is determined that the banknotes stored in the storage bag reaches the full capacity or approaches the full capacity.

In addition to the determination on the full capacity based on the first full capacity criterion or the second full capacity criterion, the sensor senses that the pusher reaches the maximum push-in position, so that the controller can accurately determine the full capacity of the banknotes.

The controller may further determine the full capacity of the banknotes stored in the storage bag based on a third full capacity criterion that the stage reaches the lowest position and the sensor does not sense that the pusher reaches the maximum push-in position.

In a case where the relatively-neat banknotes are stored in the storage bag and is relatively thick, even if the distance between the end of the stack of the banknotes and the bag opening of the storage bag is short to a certain extent, the probability of the banknote being caught by the bag opening is low. On the other hand, the volume of the stacked banknotes becomes bulkier as the thickness thereof increases, and therefore, the pusher cannot reach the maximum push-in position.

Thus, based on the third full capacity criterion, the controller determines the full capacity of the banknotes stored in the storage bag. The money storage device can store a large number of thick banknotes in the storage bag.

A drive mechanism of the pusher may have a torque limiter interposed between a drive source and the pusher.

With the torque limiter, the arrival position of the pusher can be changed according to the height of the banknotes for the same drive force generated by the drive source.

For example, by operation of the torque limiter, the arrival position of the pusher in a case where the full capacity is determined based on the first full capacity criterion may be a position in the opposite push-in direction with respect to the arrival position of the pusher in a case where the full capacity is determined based on the second full capacity criterion.

The money storage device may further include a sealing mechanism that seals the bag opening of the storage bag,
the sealing mechanism may start a sealing operation in a state of the pusher pushing the banknotes, and after the start of the sealing operation, the pusher may retract outward of the storage bag, and
the position of the pusher at the start of the sealing operation may be different between a case where the full capacity is determined based on the first full capacity criterion and a case where the full capacity is determined based on the second full capacity criterion.

The position of the pusher is closer to the sealing mechanism in the case where the full capacity is determined based on the first full capacity criterion than in the case where the full capacity is determined based on the second full capacity criterion. That is, the push-in amount of the pusher is smaller.

The push-in amount of the pusher is greater in the case where the full capacity is determined based on the second full capacity criterion.

The money storage device may further include
a first holder that holds a first edge of the bag opening of the storage bag,
a second holder that holds a second edge facing the first edge in a direction of opening and closing the bag opening, and
a third holder that holds a third edge between the first edge and the second edge,
the third holder may be supported by the first holder so as to move relative to the first holder,
by holding the first edge by the first holder and holding the second edge by the second holder in a state of the third holder holding the third edge, the third holder may be pulled by the storage bag and be positioned at a normal position, and
the money storage device may further include a second sensor that senses that the third holder is positioned at the normal position. The second sensor may be, for example, an optical sensor.

When the third edge is not held by the third holder, the third holder is not pulled by the storage bag, and therefore, does not move relative to the first holder.

When the second holder and the first holder move apart from each other in the opening-closing direction in a state of the second edge being not held by the second holder, the third holder is not pulled by the storage bag, and therefore, does not move relative to the first holder.

A money handling device disclosed herein includes
a depositing unit, and
a money storage device that stores banknotes fed out of the depositing unit,
the money storage device has
a pair of plates having accumulation surfaces on which the banknotes are accumulated in a support posture in which the pair of plates is arranged in a first direction, and
a pusher that performs a push-in operation of pushing the banknotes accumulated on the accumulation surfaces in a second direction crossing the first direction, to store the banknotes in a storage bag,
the banknotes pushed by the pusher pass between the pair of plates changed from the support posture to a passage posture, and are stored in the storage bag, and
an interval in the first direction between the pair of plates in the passage posture is narrower than the width of the banknote in the first direction.

A money storage method disclosed herein includes
accumulating banknotes on accumulation surfaces of a pair of plates in a support posture,
pushing, by a pusher, the banknotes accumulated on the accumulation surfaces toward a storage bag, and changing the pair of plates from the support posture to a passage posture,
guiding the banknotes pushed by the pusher by the accumulation surfaces of the pair of plates in the passage posture, and
causing the banknotes to pass between the pair of plates, and storing the banknotes in the storage bag.

Hereinafter, an embodiment of the money storage device, the money handling device, and the money storage method will be described with reference to the drawings. The money storage device, the money handling device, and the money storage method described herein are examples.

### (Money Handling Device)

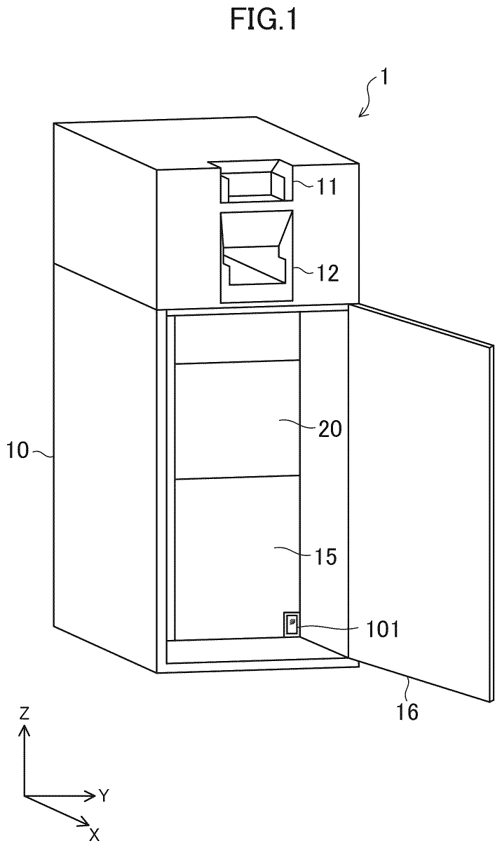

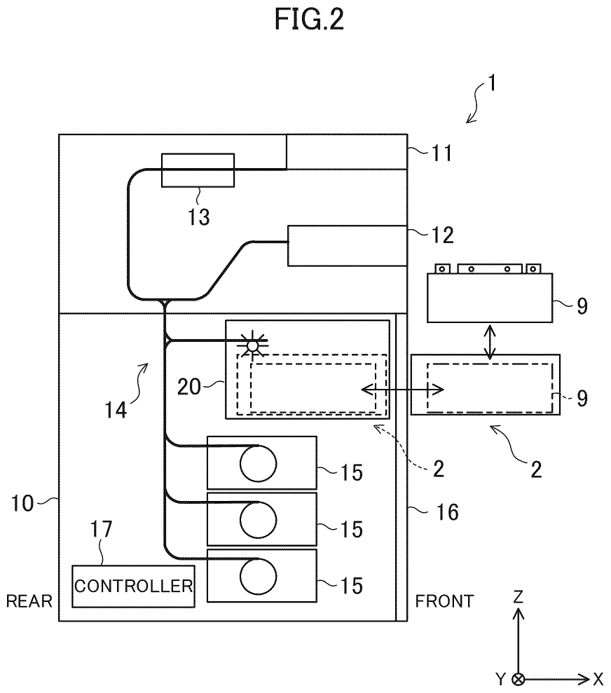

FIG. 1 shows the appearance of the money handling device. FIG. 2 shows an internal structure of the money handling device. The money handling device is a banknote handling device 1 that handles a banknote.

For the sake of convenience in description of the banknote handling device 1 and a banknote storage device 2 as a money storage device, an X-direction, a Y-direction, and a Z-direction are defined as follows. The X-direction corresponds to the front-rear direction of the banknote handling device 1. The front of the banknote handling device 1 is a side of the banknote handling device 1 that a user who uses the banknote handling device 1 faces, on which a depositing unit 11 and a dispensing unit 12 are positioned and a second storage unit 20 is pulled out. The rear of the banknote handling device 1 is a side opposite to the front of the banknote handling device 1. The Y-direction is the horizontal direction orthogonal to the X-direction, and corresponds to the left-right direction of the banknote handling device 1. The left of the banknote handling device 1 is the left with reference to the user who faces the banknote handling device 1, and the right is the right with reference to such a user. The Z-direction is a direction orthogonal to each of the X-direction and the Y-direction, and is the vertical direction. The X-direction, the Y-direction, the Z-direction, the front, and the rear are used only in the description of the banknote handling device 1 and the banknote storage device 2, and are not used to limit the structures or shapes of the banknote handling device 1 and the banknote storage device 2.

The banknote handling device 1 includes the depositing unit 11. The depositing unit 11 feeds a banknote into the device. The banknote handling device 1 includes the dispensing unit 12. The banknote handling device 1 dispenses a banknote through the dispensing unit 12. The banknote handling device 1 includes a recognition unit 13. The recognition unit 13 recognizes a banknote. The banknote handling device 1 includes a transport unit 14. The transport unit 14 transports banknotes one by one.

The banknote handling device 1 includes a first storage unit 15. The first storage unit 15 stores a banknote, and feeds out the stored banknote. The first storage unit 15 is, for example, a drum-type storage unit that winds up a banknote on the outer peripheral surface of a drum and stores the banknote. The first storage unit 15 is not limited to the drum-type storage unit. The banknote handling device 1 may include a plurality of first storage units 15. The number of first storage units 15 in the banknote handling device 1 is not limited to a particular number.

The banknote handling device 1 includes the second storage unit 20. The second storage unit 20 includes the banknote storage device 2. A storage bag 9 is attachable to the banknote storage device 2, and the banknote storage device 2 stores a banknote in the storage bag 9. The second storage unit 20 stores a banknote, but does not feed out the stored banknote.

The banknote handling device 1 performs deposit processing. In the deposit processing, the depositing unit 11 feeds banknotes into the device one by one. The transport unit 14 transports the banknotes to the recognition unit 13. The recognition unit 13 recognizes the denomination, fitness, and authenticity of each banknote, and counts the banknotes. Based on the recognition result of the recognition unit 13, the transport unit 14 transports each banknote to the first storage unit 15, the second storage unit 20, or the dispensing unit 12. The banknote which can be deposited is transported to the first storage unit 15. The plurality of first storage units 15 stores the banknotes, for example, according to denomination. The banknote which can be deposited, but cannot be stored in the first storage unit 15 is transported to the second storage unit 20. For example, in a case where the first storage unit 15 is full and cannot store the banknote, the second storage unit 20 stores the banknote in the storage bag 9. The banknote which cannot be deposited is transported to the dispensing unit 12. The banknote which cannot be deposited is returned to the user.

Moreover, the banknote handling device 1 performs collection processing using the second storage unit 20. In the collection processing, the transport unit 14 transports a banknote fed out of the first storage unit 15 to the second storage unit 20. The second storage unit 20 stores the banknote in the storage bag 9.

### (Structure for Holding Storage Bag of Banknote Storage Device)

As indicated by a horizontal arrow in FIG. 2, the banknote storage device 2 can be pulled out of a housing 10 of the banknote handling device 1 in the X-direction. When the banknote storage device 2 is pulled out of the housing 10, the storage bag 9 is attachable to or detachable from the banknote storage device 2 as indicated by an up-down arrow in FIG. 2.

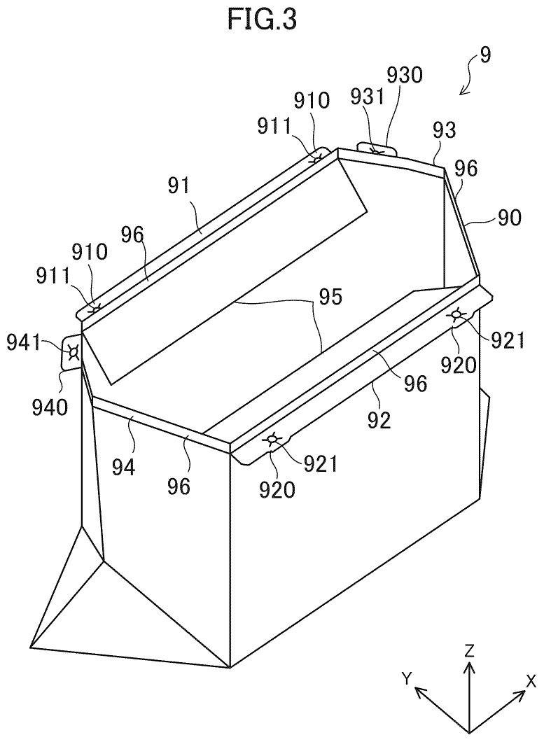

FIG. 3 shows the storage bag 9 with a bag opening 90 opened. The storage bag 9 is a flexible bag having flexibility. The storage bag 9 is made of opaque nylon, for example.

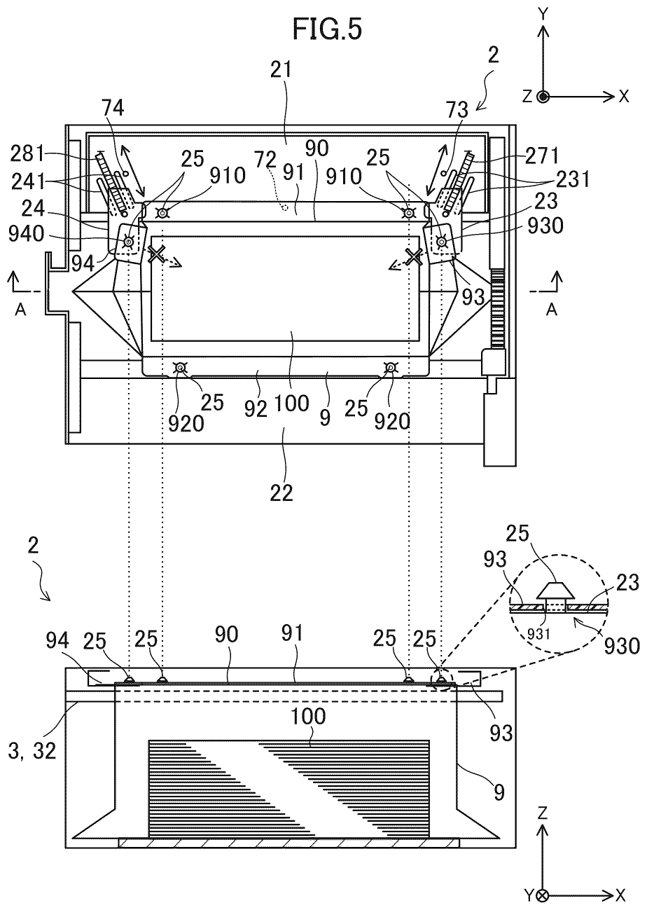

The storage bag 9 has the bag opening 90 at the upper end. A banknote is stored in the storage bag 9 through the bag opening 90. As shown in a view on the lower side in FIG. 5, banknotes are stacked on each other in the Z-direction in the storage bag 9.

The bag opening 90 has a first edge 91. The first edge 91 extends in the X-direction. The bag opening 90 has a second edge 92. The second edge 92 is an edge facing the first edge 91 in the Y-direction. The Y-direction is an opening-closing direction in which the bag opening 90 is opened and closed. The second edge 92 extends in the X-direction, similarly to the first edge 91.

The bag opening 90 has a third edge 93. The third edge 93 is positioned between the first edge 91 and the second edge 92 in the Y-direction in a state of the bag opening 90 being opened. The third edge 93 is an edge connecting the first edge 91 and the second edge 92 to each other.

The bag opening 90 has a fourth edge 94. Similarly to the third edge 93, the fourth edge 94 is positioned between the first edge 91 and the second edge 92 in the Y-direction in a state of the bag opening 90 being opened. The fourth edge 94 faces the third edge 93 in the X-direction.

Each of the first edge 91, the second edge 92, the third edge 93, and the fourth edge 94 has an engagement portion 910, 920, 930, 940.

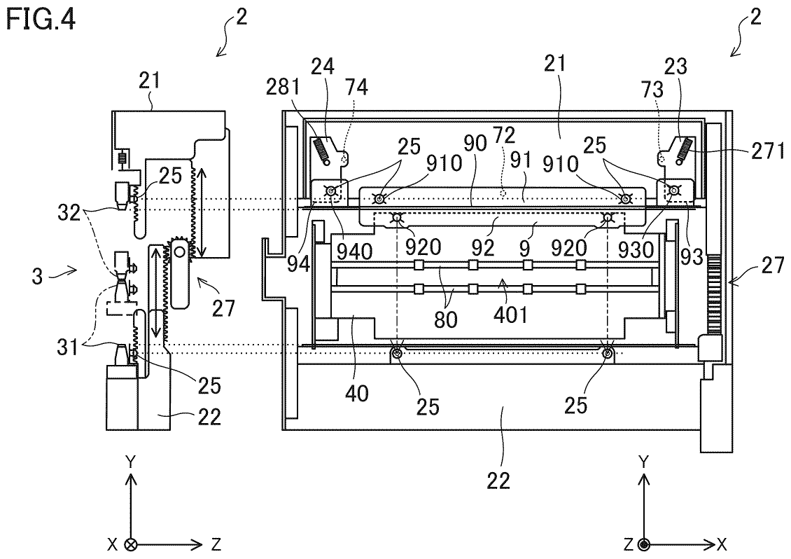

The first edge 91 has two engagement portions 910 spaced apart from each other in the X-direction. The engagement portion 910 has a through-hole 911 as an engagement hole. A pin 25 is inserted into the through-hole 911 (see FIG. 4 or FIG. 5).

The second edge 92 has two engagement portions 920 spaced apart from each other in the X-direction. The engagement portion 920 has a through-hole 921. The third edge 93 has one engagement portion 930. The engagement portion 930 has a through-hole 931. The fourth edge 94 has one engagement portion 940. The engagement portion 940 has a through-hole 941.

A view on the right side in FIG. 4 is a plan view of the banknote storage device 2, and a view on the left side is a side view of the banknote storage device 2. A view on the upper side in FIG. 5 is a plan view of the banknote storage device 2, and a view on the lower side is a sectional view of the view on the upper side, which is taken along line A-A. The plan view of FIG. 4 shows a state before the storage bag 9 is attached to the banknote storage device 2. The plan view of FIG. 5 shows a state in which the storage bag 9 is attached to the banknote storage device 2 and the bag opening 90 is opened.

The banknote storage device 2 has a first holder 21. The first holder 21 holds the first edge 91 of the storage bag 9. The first holder 21 has two pins 25. The two pins 25 are spaced apart from each other in the X-direction. The pins 25 are each engaged with the engagement portions 910. By engaging the pins 25 with the engagement portions 910, the first holder 21 holds the first edge 91.

The banknote storage device 2 has a second holder 22. The second holder 22 holds the second edge 92 of the storage bag 9. The second holder 22 faces the first holder 21 in the Y-direction. The second holder 22 has two pins 25. The pins 25 are each engaged with the engagement portions 920. By engaging the pins 25 with the engagement portions 920, the second holder 22 holds the second edge 92.

The banknote storage device 2 has a rack-and-pinion mechanism 27. The rack-and-pinion mechanism 27 reciprocates the first holder 21 and the second holder 22 in the Y-direction (see an arrow in the view on the left side in FIG. 4). The first holder 21 and the second holder 22 switch between a state of being separated from each other in the Y-direction and a state of approaching each other in the Y-direction.

The banknote storage device 2 has a third holder 23. The third holder 23 holds the third edge 93. The third holder 23 is positioned at a first end portion of the first holder 21 in the X-direction, that is, a right end portion in FIG. 4 or FIG. 5.

The third holder 23 has the pin 25. The pins 25 is engaged with the engagement portion 930. As shown in closeup in the view on the lower side in FIG. 5, by engaging the pin 25 with the engagement portion 930, the third holder 23 holds the third edge 93.

The third holder 23 is supported so as to move relative to the first holder 21 (see arrows at both ends in the view on the upper side in FIG. 5). The first holder 21 has a guide groove 231 that guides the third holder 23. The guide groove 231 tilts inward of the storage bag 9 with respect to the Y-direction. The third holder 23 can reciprocate along the guide groove 231.

The third holder 23 can change its position between a first position and a second position. As shown in FIG. 4, the first position of the third holder 23 is a position at which the pin 25 of the third holder 23 is substantially at the same position as those of the pins 25 of the first holder 21 in the Y-direction. As shown in FIG. 5, the second position of the third holder 23 is a position at which the pin 25 of the third holder 23 is closer to the second holder 22 than the pins 25 of the first holder 21 in the Y-direction.

A tension spring 271 is interposed between the third holder 23 and the first holder 21. The tension spring 271 applies biasing force to the third holder 23 such that the third holder 23 is positioned at the first position. By pulling the pin 25 by the storage bag 9 in a state of the pin 25 being engaged with the engagement portion 930, the third holder 23 is positioned at the second position against the biasing force of the tension spring 271.

The banknote storage device 2 has a fourth holder 24. The fourth holder 24 holds the fourth edge 94. The fourth holder 24 is positioned at a second end portion of the first holder 21 in the X-direction, that is, a left end portion in FIG. 4 or FIG. 5. The fourth holder 24 is positioned on the side opposite to the third holder 23 in the X-direction.

The fourth holder 24 has the pin 25. The pin 25 is engaged with the engagement portion 940. By engaging the pin 25 with the engagement portion 940, the fourth holder 24 holds the fourth edge 94.

The fourth holder 24 is supported by the first holder 21. The fourth holder 24 is supported so as to move relative to the first holder 21 in the Y-direction (see arrows at both ends in the view on the upper side in FIG. 5). The first holder 21 has an inclined guide groove 241. The fourth holder 24 guided by the guide groove 241 can change its position between a first position and a second position.

A tension spring 281 is interposed between the fourth holder 24 and the first holder 21. The tension spring 281 applies biasing force to the fourth holder 24 such that the fourth holder 24 is positioned at the first position. The fourth holder 24 moves similarly to the third holder 23.

The banknote storage device 2 has a sealing mechanism 3 that seals the bag opening 90 of the storage bag 9. Before the storage bag 9 storing a banknote is detached from the banknote storage device 2, the sealing mechanism 3 irreversibly seals the bag opening 90 of the storage bag 9.

As shown in the view on the left side in FIG. 4, the sealing mechanism 3 has a heater 31 and a receiving unit 32. The heater 31 applies heat to the storage bag 9. The sealing mechanism 3 seals the bag opening 90 of the storage bag 9 by heat welding. The heater 31 is supported by the second holder 22. The heater 31 moves in the Y-direction along with movement of the second holder 22 in the Y-direction.

The receiving unit 32 is a unit facing the heater 31 in the Y-direction and sandwiching the storage bag 9 in the Y-direction between the receiving unit 32 and the heater 31. The receiving unit 32 is supported by the first holder 21. The receiving unit 32 moves in the Y-direction along with movement of the first holder 21 in the Y-direction. As indicated by a chain double-dashed line in FIG. 4, the heater 31 and the receiving unit 32 close to each other in the Y-direction can sandwich the storage bag 9 in the Y-direction. The sealing mechanism 3 can seal the bag opening 90 of the storage bag 9. The heater 31 and the receiving unit 32 may switch positions with each other.

### (Attachment of Storage Bag)

The storage bag 9 is attached to the banknote storage device 2 by a staff. The staff engages the engagement portions 910, 920, 930, 940 of the storage bag 9 with the pins 25 one by one.

As shown in FIG. 4, in a state before the banknote storage device 2 is pulled out of the housing 10 and the storage bag 9 is attached to the banknote storage device 2, the first holder 21 and the second holder 22 are positioned apart from each other in the Y-direction. In FIG. 4, the pins 25 of the first edge 91 are engaged with the engagement portions 910, the pin 25 of the third edge 93 is engaged with the engagement portion 930, and the pin 25 of the fourth edge 94 is engaged with the engagement portion 940. Each of the third holder 23 and the fourth holder 24 is positioned at the first position by the biasing force of the tension spring 271, 281.

The staff holds the second edge 92 of the storage bag 9 by the second holder 22 (see a chain double-dashed arrow in FIG. 4). Specifically, the staff inserts the engagement portions 920 of the second edge 92 onto the pins 25 of the second holder 22 while opening the bag opening 90 of the storage bag 9.

When the second holder 22 holds the second edge 92, each of the third holder 23 and the fourth holder 24 is pulled toward the second holder 22 by the storage bag 9, as shown in FIG. 5. Each of the third holder 23 and the fourth holder 24 moves from the first position to the second position against the biasing force of the tension spring 271, 281. In a state of the bag opening 90 of the storage bag 9 being opened, the third holder 23 is shifted from the first holder 21 and the second holder 22 in the X-direction at a position between the first holder 21 and the second holder 22 in the Y-direction. The fourth holder 24 is also shifted from the first holder 21 and the second holder 22 in the X-direction at a position between the first holder 21 and the second holder 22 in the Y-direction.

In this manner, the bag opening 90 of the storage bag 9 attached to the banknote storage device 2 is opened upward. When the storage bag 9 is attached to the banknote storage device 2, the staff returns the banknote storage device 2 into the housing 10. The banknote handling device 1 can execute banknote processing.

The banknote storage device 2 stores a banknote in the storage bag 9 through the opened bag opening 90. The bag opening 90 of the storage bag 9 is held at the first edge 91, the second edge 92, the third edge 93, and the fourth edge 94 by the first holder 21, the second holder 22, the third holder 23, and the fourth holder 24. The bag opening 90 of the storage bag 9 can be stably maintained in the opened shape. Since the opened shape of the bag opening 90 of the storage bag 9 is stably maintained, the size of the bag opening 90 can be minimized according to the size of a banknote 100, as shown in the view on the upper side in FIG. 5.

The third holder 23 and the fourth holder 24 hold the third edge 93 and the fourth edge 94 at positions outside the banknote 100 in the X-direction. This prevents the third edge 93 and/or the fourth edge 94 from tilting inward of the bag opening 90, and accordingly, prevents interference with the banknote 100 (see white cross marks in the view on the upper side in FIG. 5).

The structure of holding the third edge 93 and the fourth edge 94 by the third holder 23 and the fourth holder 24 reduces drooping of the third edge 93 and/or the fourth edge 94. Even when the position of the sealing mechanism 3 is closer to the bag opening 90 of the storage bag 9 in the Z-direction, the sealing mechanism 3 can seal the bag opening 90 of the storage bag 9. As a result, the capacity of the storage bag 9 can be increased, and/or the size of the banknote storage device 2 in the Z-direction can be reduced.

### (Sealing of Storage Bag)

When the storage bag 9 storing a banknote is detached from the banknote handling device 1, the banknote storage device 2 seals the bag opening 90 of the storage bag 9. First, the banknote storage device 2 causes the first holder 21 and the second holder 22 to approach each other in the Y-direction such that the first edge 91 and second edge 92 of the bag opening 90 of the storage bag 9 contact each other in the Y-direction. Along with movement of the first holder 21 and the second holder 22, each of the third holder 23 and the fourth holder 24 moves to the first position by restoring force of the tension spring 271, 281. The bag opening 90 of the storage bag 9 is closed.

When the first holder 21 and the second holder 22 approach each other and the bag opening 90 of the storage bag 9 is closed, the heater 31 and receiving unit 32 of the sealing mechanism 3 sandwich the storage bag 9 to seal the bag opening 90. After sealing of the bag opening 90 of the storage bag 9, the banknote storage device 2 is pulled out of the housing 10 of the banknote handling device 1. In the manner opposite to that described above, the staff can take the storage bag 9 out of the banknote storage device 2 by detaching the engagement portions 910, 920, 930, 940 of the storage bag 9 from the pins 25 one by one.

### (Structure of Securing Correct Attachment of Storage Bag)

For stably storing a banknote in the storage bag 9, it is necessary to correctly attach the storage bag 9 to the banknote storage device 2 as shown in FIG. 5. Moreover, for reliably sealing the bag opening 90 of the storage bag 9, it is also important to correctly attach the storage bag 9 to the banknote storage device 2.

The storage bag 9 is attached to or detached from the banknote storage device 2 (that is, second storage unit 20) in a state in which the staff opens a door 16 of the banknote handling device 1 and the inside of the housing 10 of the banknote handling device 1 is exposed as shown in FIG. 1. In order to ensure the security of the banknote handling device 1, the banknote handling device 1 is provided with a limitation on opening and closing of the door 16. Specifically, the limitation is that only an authorized staff can open the door 16 (that is, first limitation) and the door 16 cannot be opened again as long as a predetermined time does not lapse after closing of the door 16 (that is, second limitation).

In order to smoothly complete a process of detaching and attaching the storage bag 9, the banknote handling device 1 monitors whether or not the storage bag 9 is correctly attached, and in a case where the storage bag 9 is not correctly attached, alerts the staff before the door 16 is closed.

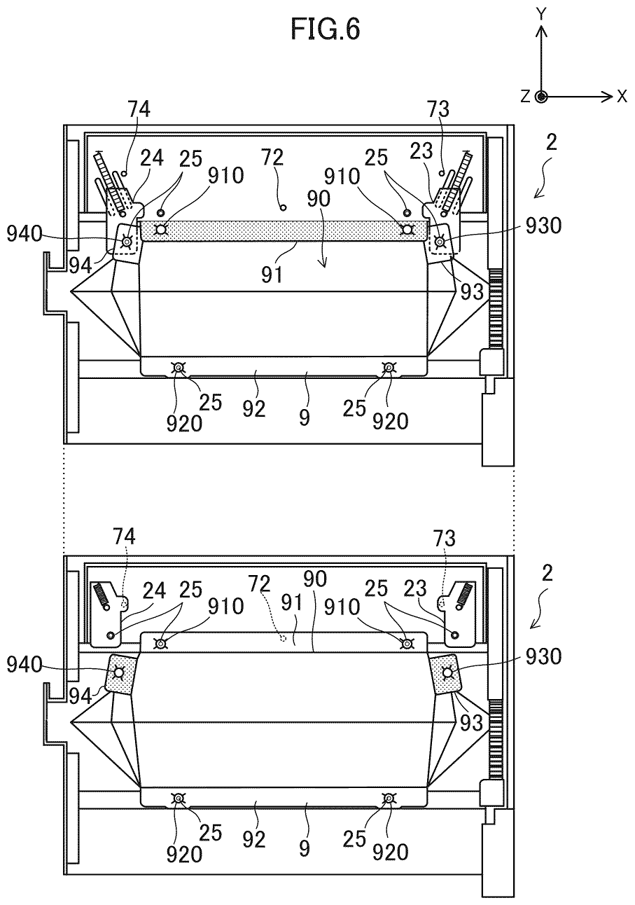

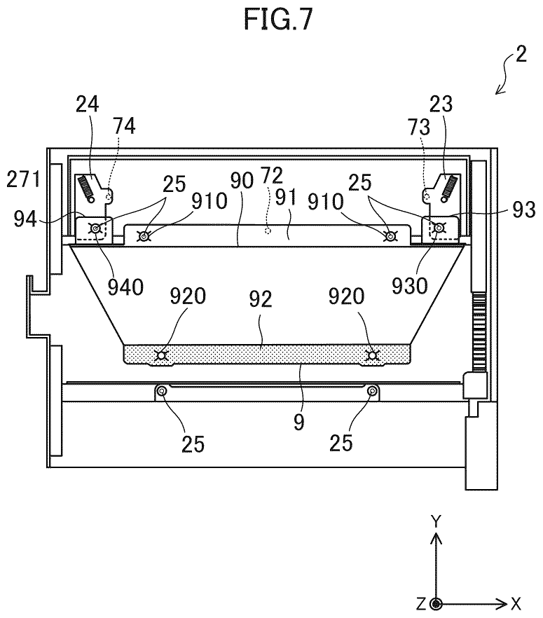

The banknote storage device 2 has a first optical sensor 72 as shown in FIG. 4 or FIG. 5. The first optical sensor 72 is positioned between the pin 25 and pin 25 of the first holder 21. As shown in a view on the upper side in FIG. 6, when the engagement portions 910 of the first edge 91 of the storage bag 9 are not engaged with the pins 25, the first optical sensor 72 is in a light transmittable state. In FIGS. 6 and 7, an edge which is not correctly attached is shaded. As shown in FIG. 4 or FIG. 5, when the engagement portions 910 of the first edge 91 of the storage bag 9 are engaged with the pins 25, the first optical sensor 72 is in a light blocking state. The first optical sensor 72 can detect whether or not the first edge 91 is held by the first holder 21.

The banknote storage device 2 has a second optical sensor 73 as shown in FIG. 4 or FIG. 5. The second optical sensor 73 is positioned corresponding to the position of the third holder 23 in the first holder 21. As shown in FIG. 4, when the third holder 23 is positioned at the first position, the second optical sensor 73 is in a light blocking state. As shown in FIG. 5, when the third holder 23 is positioned at the second position, the second optical sensor 73 is in a light transmittable state.

The banknote storage device 2 has a third optical sensor 74. The third optical sensor 74 is positioned corresponding to the position of the fourth holder 24 in the first holder 21. As shown in FIG. 4, when the fourth holder 24 is positioned at the first position, the third optical sensor 74 is in a light blocking state. As shown in FIG. 5, when the fourth holder 24 is positioned at the second position, the third optical sensor 74 is in a light transmittable state.

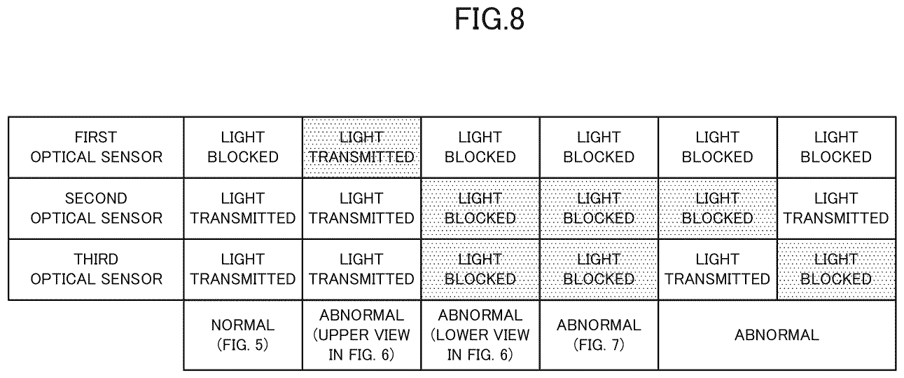

FIG. 8 shows a correspondence between a detection state of each of the first optical sensor 72, the second optical sensor 73, and the third optical sensor 74 and an attachment state of the storage bag 9. As shown in FIG. 5, when the first edge 91, the second edge 92, the third edge 93, and the fourth edge 94 are each held by the first holder 21, the second holder 22, the third holder 23, and the fourth holder 24, the first optical sensor 72 is in the light blocking state, and the second optical sensor 73 and the third optical sensor 74 are both in the light transmittable state. This state corresponds to correct attachment of the storage bag 9 (that is, normal state).

As shown in the view on the upper side in FIG. 6, when the first edge 91 is not held by the first holder 21, the first optical sensor 72 is in the light transmittable state. This state corresponds to incorrect attachment of the storage bag 9 (that is, abnormal state).

As shown in a view on the lower side in FIG. 6, when the third edge 93 and the fourth edge 94 are not held by the third holder 23 and the fourth holder 24, even if the second edge 92 is held by the second holder 22, the third holder 23 and the fourth holder 24 do not move to the second position. The second optical sensor 73 and the third optical sensor 74 are in the light blocking state. This state corresponds to incorrect attachment of the storage bag 9 (that is, abnormal state).

As shown in FIG. 7, when the second edge 92 is not held by the second holder 22, the third holder 23 and the fourth holder 24 do not move to the second position, and therefore, the second optical sensor 73 and the third optical sensor 74 are in the light blocking state. This state corresponds to incorrect attachment of the storage bag 9 (that is, abnormal state).

When only the third edge 93 is not held by the third holder 23, the second optical sensor 73 is in the light blocking state, and therefore, this state also corresponds to incorrect attachment of the storage bag 9 (that is, abnormal state). When only the fourth edge 94 is not held by the fourth holder 24, the third optical sensor 74 is in the light blocking state, and therefore, this state also corresponds to incorrect attachment of the storage bag 9 (that is, abnormal state).

In addition, when only either one of the engagement portions 920 of the second edge 92 is not engaged with the pin 25, the second optical sensor 73 or the third optical sensor 74 is in the light blocking state. This state also corresponds to incorrect attachment of the storage bag 9 (that is, abnormal state).

When only either one of the engagement portions 910 of the first edge 91 is not engaged with the pin 25, the first optical sensor 72 is in the light blocking state. This state also corresponds to incorrect attachment of the storage bag 9 (that is, abnormal state).

Using a smaller number of sensors than the number of pins 25, the banknote storage device 2 can determine the attachment state of the storage bag 9. Moreover, the second optical sensor 73 and the third optical sensor 74 detect the positions of the third holder 23 and the fourth holder 24, so that the banknote storage device 2 can sense the attachment state of the second edge 92 without providing an optical sensor for the second holder 22.

For example, by connecting the second optical sensor 73 and the third optical sensor 74 by a prism, either one of the second optical sensor 73 or the third optical sensor 74 can be omitted.

A controller 17 (see FIG. 2) of the banknote handling device 1 may issue a warning to the staff, for example, at the timing when the banknote storage device 2 to which the storage bag 9 is attached is returned into the housing 10. The warning may be made via an interface (for example, display device) provided for the banknote handling device 1 or a terminal connected to the banknote handling device 1.

According to an exemplary embodiment, the controller 17 is, for example, one or more general-purpose processing circuits such as a microprocessor, a microcontroller, and a digital signal processor, or a dedicated processing circuit such as an application specific integrated circuit (ASIC).

The controller 17 may issue the warning to the staff at the timing before the door 16 is closed. Specifically, the controller 17 may alert the staff using a light emitter 101 (see FIG. 1) placed inside the housing 10 of the banknote handling device 1, such as a light emitting diode (LED). Based on the detection results of the first optical sensor 72, the second optical sensor 73, and the third optical sensor 74, in a case where the storage bag 9 is correctly attached to the banknote storage device 2, the controller 17 may turn on the light emitter 101 in blue. In a case where the storage bag 9 is not correctly attached to the banknote storage device 2, the controller 17 may turn on the light emitter 101 in red or cause the light emitter 101 to blink. In a case where the light emitter 101 issues the warning, it can be expected that the staff notices the warning, stops closing the door 16, and attaches the storage bag 9 to the banknote storage device 2 again.

### (Structure of Stably and Quickly Storing Banknote in Storage Bag)

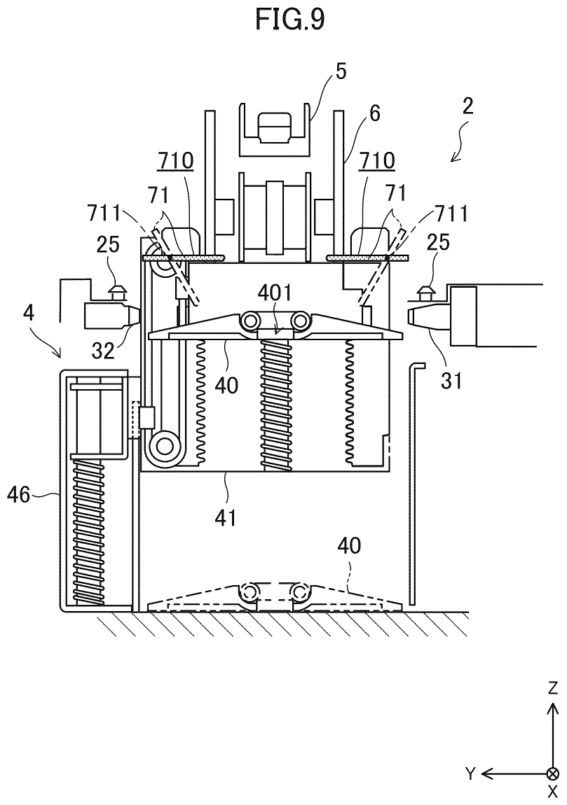

The banknote storage device 2 has a structure capable of stably and quickly storing a banknote in the storage bag 9. FIG. 9 is a side view of the banknote storage device 2. The banknote storage device 2 includes a stage 40. The stage 40 supports a banknote stored in the storage bag 9.

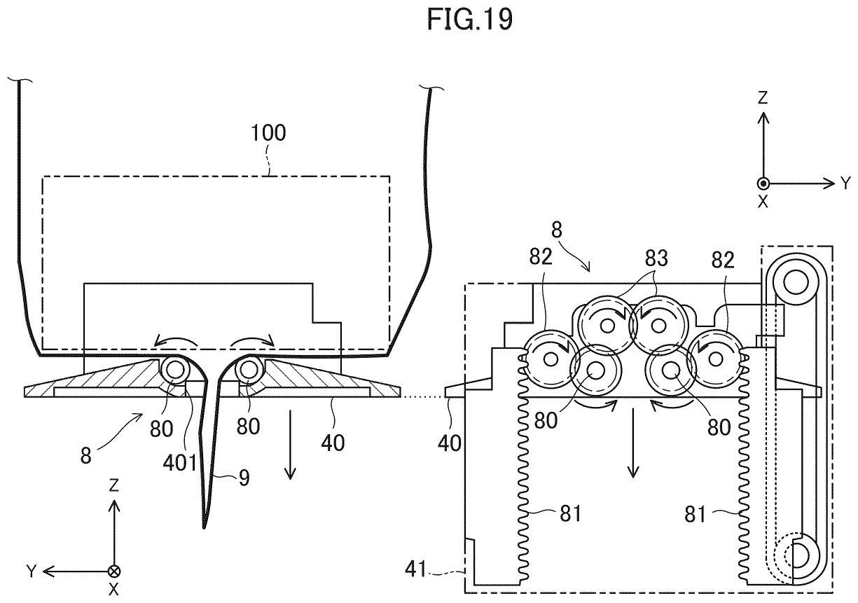

As shown in the view on the right side in FIG. 4, the stage 40 extends in the X-direction and the Y-direction. The stage 40 has, in a center portion thereof, a slit 401 extending in the X-direction. The slit 401 penetrates the stage 40 in the Z-direction. As shown in FIG. 19, the storage bag 9 passes through the slit 401. The stage 40 supports a banknote 100 stored in the storage bag 9 in a state of the storage bag 9 being sandwiched between the stage 40 and the banknote 100.

The banknote storage device 2 includes a lifting-lowering mechanism 4. The lifting-lowering mechanism 4 lifts and lowers the stage 40 in the Z-direction. The lifting-lowering mechanism 4 is one example of a movement mechanism.

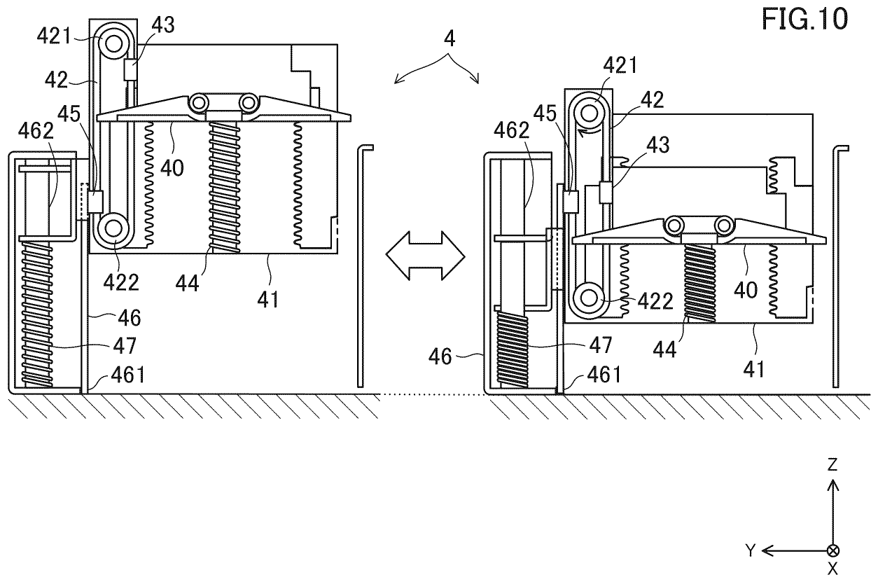

FIG. 10 shows the lifting-lowering mechanism 4. A view on the left side in FIG. 10 shows a state in which the stage 40 is positioned at the highest position, and a view on the right side shows a state in which the stage 40 is positioned at an intermediate position. The position of the stage 40 indicated by a chain double-dashed line in FIG. 9 is the lowest position.

The lifting-lowering mechanism 4 has a first base 41. The first base 41 supports the stage 40 such that the stage 40 reciprocates in the Z-direction. The first base 41 has a belt 42. The belt 42 is wound around a pair of pulleys 421, 422. The pair of pulleys 421, 422 is supported by the first base 41 with a gap therebetween in the Z-direction. The belt 42 extends in the Z-direction.

A first carriage 43 is fixed to the belt 42. The first carriage 43 is engaged with the stage 40. When the first carriage 43 moves in the Z-direction in such a manner that the belt 42 turns clockwise or counterclockwise in FIG. 10, the stage 40 moves in the Z-direction together with the first carriage 43.

The first base 41 has a first compression spring 44. The first compression spring 44 biases the stage 40 upward when the stage 40 is pressed down.

A second carriage 45 is further fixed to the belt 42. The second carriage 45 is fixed to the belt 42, which is wound around the pair of pulleys 421, 422, on the opposite side of the pulleys 421, 422 from the first carriage 43.

The lifting-lowering mechanism 4 has a second base 46. A frame 461 of the second base 46 is fixed on the housing 10 side of the banknote storage device 2. The frame 461 does not move. The second base 46 supports the first base 41 such that the first base 41 lifts and lowers in the Z-direction. The first base 41 lifts and lowers in the Z-direction along a guide pole 462 of the second base 46.

The second carriage 45 is fixed to the frame 461. The second carriage 45 does not move. By running the belt 42 clockwise or counterclockwise in FIG. 10, the first base 41 supporting the belt 42 moves in the Z-direction. By running the belt 42, the first base 41 moves in the Z-direction, and the stage 40 moves in the Z-direction relative to the first base 41. The lifting-lowering mechanism 4 can be configured such that the amount of movement of the stage 40 in the Z-direction is twice the amount of running of the belt 42. The stage 40 can lift and lower between the highest position indicated by a solid line in FIG. 9 and the lowest position indicated by a chain double-dashed line. Since the lifting-lowering mechanism 4 has the first base 41 and the second base 46, the amount of lifting and lowering of the stage 40 can be increased with a structure compact in the Z-direction. Moreover, the lifting-lowering mechanism 4 can greatly move the stage 40 by one drive source that runs the belt 42.

The second base 46 has a second compression spring 47. The second compression spring 47 is supported by the guide pole 462. The second compression spring 47 biases the first base 41 upward when the first base 41 is pressed down.

As shown in FIG. 9, the banknote storage device 2 includes a pusher 5. The pusher 5 pushes a banknote 100 into the storage bag 9. The pusher 5 moves in the Z-direction. The banknote storage device 2 includes a drive mechanism 6. The drive mechanism 6 reciprocates the pusher 5 in the Z-direction.

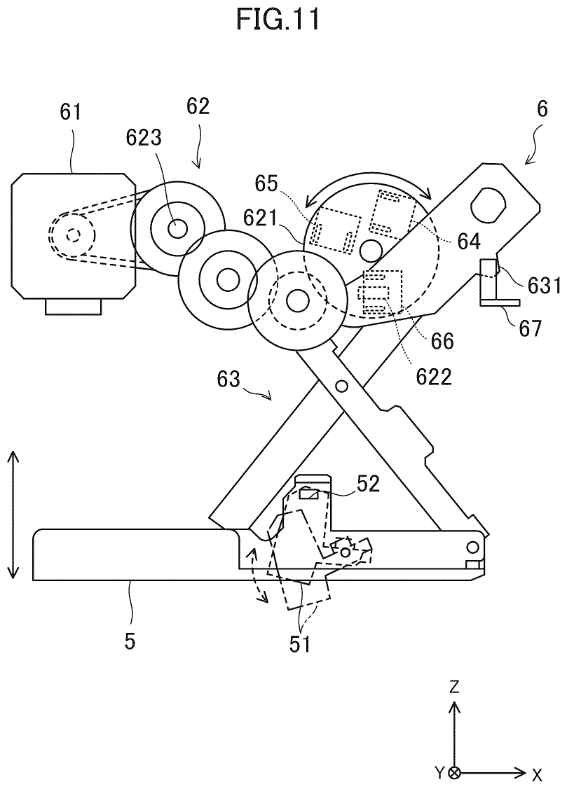

FIG. 11 is a side view of the pusher 5 and the drive mechanism 6. The drive mechanism 6 has a drive source 61. The drive source 61 is an electric motor. The drive source 61 may be, for example, a stepping motor.

The drive mechanism 6 has a gear train 62. The gear train 62 includes a plurality of gears engaged with each other. The gear train 62 decelerates rotation of the drive source 61 and transmits such rotation.

The drive mechanism 6 has a link mechanism 63. The link mechanism 63 is connected to a drive gear 621 of the gear train 62. The link mechanism 63 also supports the pusher 5. As indicated by a solid arrow in FIG. 11, the link mechanism 63 converts rotation of the drive gear 621 into up-down movement of the pusher 5.

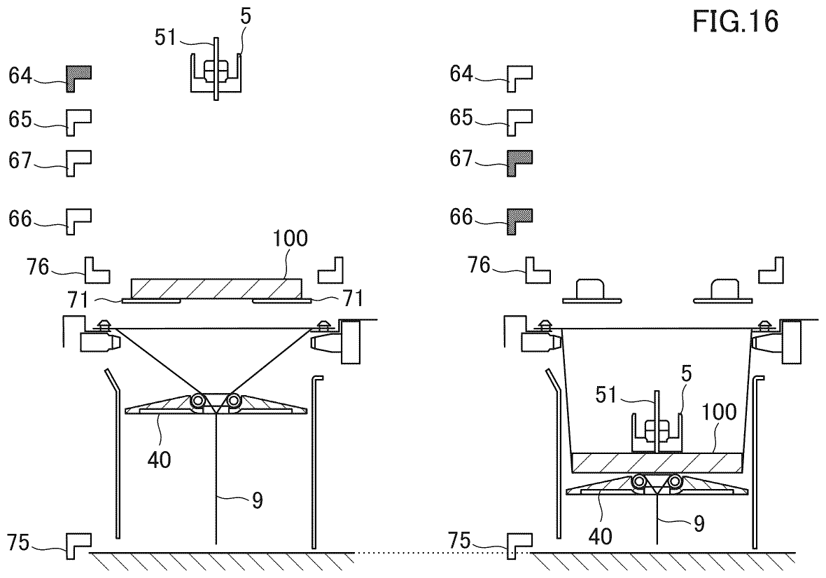

By driving the drive mechanism 6, the pusher 5 can move in the Z-direction between a standby position shown in a view on the left side in FIG. 16 and a push-in position shown in a view on the right side. The push-in position is a position at which the pusher 5 pushes a banknote 100 into the storage bag 9.

As shown in FIG. 9, the banknote storage device 2 includes a pair of plates 71. Banknotes are temporarily accumulated on the pair of plates 71. Each plate 71 has a predetermined width in the Y-direction, and extends in the X-direction. The plate 71 has such a size that banknotes 100 can be stably accumulated.

The pair of plates 71 is spaced apart from each other in the Y-direction. An interval between the pair of plates 71 is greater than the width of the pusher 5. The pusher 5 can pass between the pair of plates 71 in the Z-direction.

The pair of plates 71 is each pivotally supported by pivot shafts 711 extending in the X-direction. The pair of plates 71 can change its posture between the horizontal posture indicated by a solid line in FIG. 9 and an inclined posture indicated by a chain double-dashed line. The pivot shaft 711 is positioned in the middle of the plate 71 extending in the Y-direction.

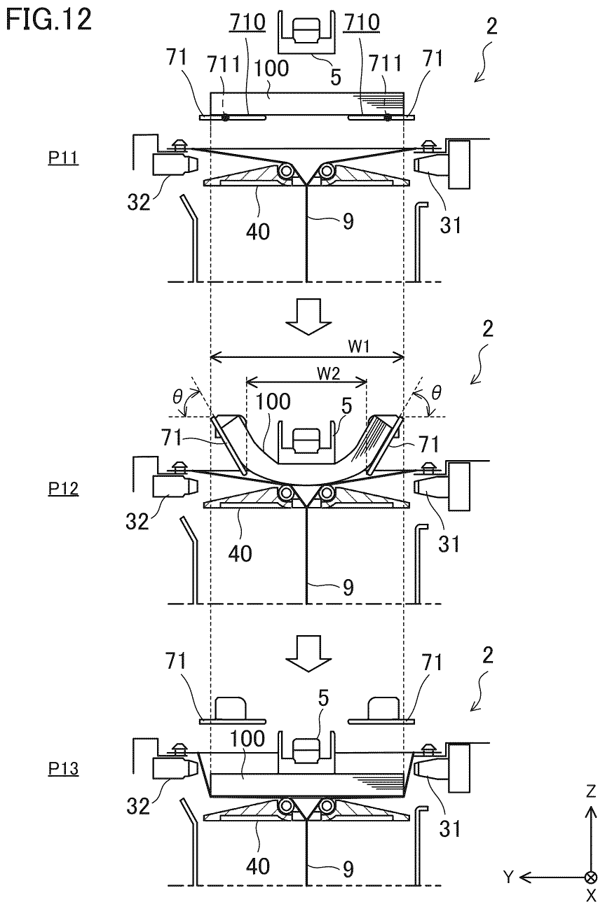

As shown in a view on the upper side in FIG. 12, banknotes 100 can be stacked on the pair of plates 71 in the horizontal posture. The upper surface of the plate 71 is an accumulation surface 710. Hereinafter, the horizontal posture will be referred to as a support posture of the pair of plates 71.

As shown in a view in the middle in FIG. 12, the pair of plates 71 in the inclined posture has a wide interval between the upper ends thereof, and is inclined in such a direction that an interval between the lower ends is narrowed. The pair of plates 71 in the inclined posture guides a banknote 100 to be stored in the storage bag 9. Hereinafter, the inclined posture will be referred to as a passage posture of the pair of plates 71. The angle θ of the pair of plates 71 in the passage posture with respect to the pair of plates 71 in the support posture is set to 80° or less. The angle θ may be, for example, 80°.

FIG. 12 is an operation transition view of the banknote storage device 2 when a banknote is stored in the storage bag 9. FIG. 12 shows a case where no banknote 100 is stored in the storage bag 9.

In Step P11, the pair of plates 71 is in the support posture. Banknotes 100 are accumulated on the accumulation surface 710. A predetermined number of banknotes 100 is accumulated on the accumulation surface 710. The predetermined number may be set to an arbitrary number of 20 to 40. The banknote storage device 2 stores the banknotes 100, which are accumulated on the accumulation surface 710, all at once in the storage bag 9. The number of banknotes 100 to be accumulated is relatively great. In a case where the number of banknotes 100 to be accumulated is great, when many banknotes 100 are stored in the storage bag 9, the number of times of the storage operation by the banknote storage device 2 decreases.

When the predetermined number of banknotes 100 is accumulated on the accumulation surface 710, the pusher 5 lowers to push down the banknotes 100 in Step P12. The pair of plates 71 changes its posture from the support posture to the passage posture. The banknotes 100 are sandwiched by the pusher 5 and the plates 71, and accordingly, are bent downward, in other words, the pressing direction of the pusher 5. The bent banknotes 100 pass downward between the plate 71 and the plate 71.

When no banknote 100 is stored in the storage bag 9, the stage 40 is positioned at the highest position. The banknotes 100 are sandwiched by the pusher 5 and the stage 40. Since the lifting-lowering mechanism 4 can move the stage 40 closer to the position of the plate 71, the pusher 5 and the stage 40 can hold the banknotes 100.

The pusher 5 pushes the stage 40, and accordingly, the stage 40 lowers. The stage 40 keeps holding the banknotes 100 by the biasing force of the first compression spring 44 and/or the second compression spring 47. Since the pusher 5 and the stage 40 lower with the banknotes 100 held by the pusher 5 and the stage 40, the banknote storage device 2 can stably move the banknotes 100.

In Step P13, the banknotes 100 pass between the pair of plates 71, and are completely stored in the storage bag 9.

The interval W2 between the pair of plates 71 in the passage posture is narrower than the width W1 of the accumulated banknotes 100 in the Y-direction. The position of the banknotes 100, which are to be pushed into the storage bag 9, in the Y-direction is limited by guide of the accumulation surfaces 710 of the plates 71, and therefore, the size of the bag opening 90 of the storage bag 9, particularly the width of the bag opening 90 in the Y-direction, is not necessarily increased. The positions of the heater 31 and the receiving unit 32 can be closer to the storage bag 9, and the banknote storage device 2 can be reduced in size in the Y-direction.

Since the pair of plates 71 can change its posture from the support posture to the passage posture, the number of banknotes 100 to be stored in the storage bag 9 all at once can be increased as compared to a case where the pair of plates does not move, and the number of times of accumulation of the banknotes 100 on the pair of plates 71 and the number of times of pushing of the banknotes 100 by the pusher 5 can be decreased in the banknote storage device 2. The banknote storage device 2 can quickly complete storage, for example, in a case where the banknotes 100 are stored in the collection processing until the storage bag 9 becomes full.

### (Modifications of Plate)

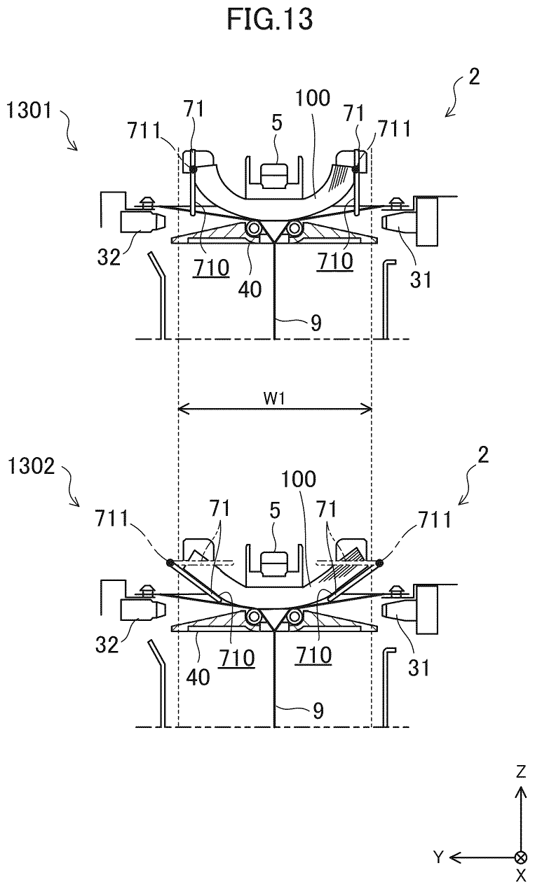

FIG. 13 shows modifications of the plate 71. As shown in a view 1301 on the upper side in FIG. 13, the pair of plates 71 in the passage posture may turn so as to be parallel with each other in the Y-direction. The interval between the pivot shafts 711 of the pair of plates 71 is narrower than the width W1 of the banknote 100, and therefore, the interval between the plate 71 and the plate 71 parallel with each other is also narrower than the width W1 of the banknote 100. The accumulation surfaces 710 of the pair of plates 71 can guide the banknotes 100, and the banknote storage device 2 can be reduced in size in the Y-direction.

The modification shown in a view 1302 on the lower side in FIG. 13 is a modification of the position of the pivot shaft 711 of the plate 71. The pivot shaft 711 may be positioned at an end of the plate 71. In this modification, the angle θ of each of the pair of plates 71 in the passage posture with respect to that in the support posture may be 80° or less. The interval between the pair of plates 71 in the passage posture is narrower than the width W1 of the banknote 100. The accumulation surfaces 710 of the pair of plates 71 can guide the banknotes 100, and the banknote storage device 2 can be reduced in size in the Y-direction.

(Configuration of Determining Full capacity of Storage Bag)

For the banknote storage device 2, size reduction in the accumulation direction and a great amount of storage in the storage bag 9 are demanded.

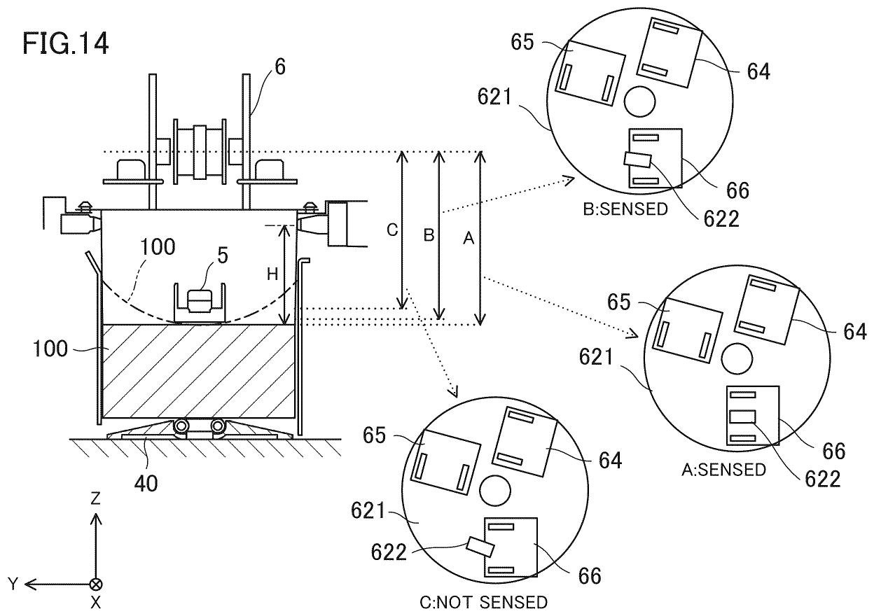

The banknote storage device 2 seals the bag opening 90 of the storage bag 9 by heat welding. In order for stored banknotes 100 not to be caught by the bag opening 90 when the bag opening 90 is sealed, a sufficiently-long height difference H (see FIG. 14) between a sealing position and an end of the stack of the banknotes 100 stacked on each other in the storage bag 9 is ensured. The full capacity of the banknotes 100 stored in the storage bag 9 is such a capacity that the distance between the end of the stack of the banknotes 100 and the sealing position is set to such a length that the stored banknotes 100 are not caught at the time of sealing the storage bag 9.

If banknotes stored in the storage bag 9 are, for example, so-called wrinkled notes with many wrinkles, the volume of the banknotes stacked on each other in the storage bag 9 increases, and therefore, these banknotes are bulkier than a volume corresponding to the number of banknotes 100. A probability of the banknotes being caught by the bag opening 90 when the bag opening 90 is sealed increases. For this reason, as shown in FIG. 14, the banknote storage device 2 compresses, using the pusher 5, the banknotes 100 stacked on each other in the storage bag 9. A chain double-dashed line in FIG. 14 indicates, as an example, rising of the banknotes 100 deviated from the pusher 5 when the pusher 5 compresses the banknotes 100.

In the case of the so-called wrinkled notes, if the amount of compression of the banknotes 100 increases, the banknote storage device 2 can ensure a long distance between the end of the stack of the banknotes 100 and the sealing position. The full capacity of the banknotes 100 stored in the storage bag 9 can be set with reference to the increased compression amount.

Contrary to the wrinkled notes, in a case where the banknotes 100 stored in the storage bag 9 are, for example, relatively-neat uncirculated banknotes, the banknotes 100 stacked on each other in the storage bag 9 are not bulky and have the volume corresponding to the number of banknotes 100. In the case of the uncirculated banknotes, the banknotes 100 cannot be substantially compressed using the pusher 5, but even in a case where these banknotes 100 are pushed by the pusher 5, the banknotes 100 deviated from the pusher 5 are less likely to rise as compared to the wrinkled banknotes. Even in a case where a distance between the sealing position and an end of the stack of the uncirculated banknotes stacked on each other in the storage bag 9 is short to a certain extent, the probability of the banknote 100 being caught by the bag opening 90 is low. In the case of the relatively-neat banknotes 100, there is no interference with sealing of the storage bag 9 even if the storage amount is greater than that in the case of the wrinkled banknotes.

Further, even in the case of the uncirculated banknotes, there are a case of a thick uncirculated banknote and a case of a thin uncirculated banknote according to the type of banknote 100. In a case where the banknote 100 is thick, the end of the stack of the uncirculated banknotes stacked on each other in the storage bag 9 is at a high position in the Z-direction, but the probability of the banknote 100 as the uncirculated banknote being caught by the bag opening 90 is low as described above.

In order not only to stably seal the storage bag 9 but also to increase the storage amount of the storage bag 9 as great as possible, the banknote storage device 2 determines, according to a plurality of full capacity criteria, the full capacity of the banknotes 100 stored in the storage bag 9. The full capacity criteria include a first full capacity criterion, a second full capacity criterion, and a third full capacity criterion.

The first full capacity criterion is that the number of banknotes 100 stored in the storage bag 9 reaches a full capacity number. The number of banknotes 100 stored in the storage bag 9 is determined in such a manner that the number of banknotes 100 transported to the banknote storage device 2, that is, the second storage unit 20, is counted by the controller 17. The first full capacity criterion is a criterion in a case where relatively-neat banknotes 100 are stored in the storage bag 9.

The second full capacity criterion is that the number of banknotes 100 stored in the storage bag 9 is less than the above-described full capacity number and the end of the stack of the banknotes 100 stacked on each other in the storage bag 9 reaches a full capacity position. The second full capacity criterion is a criterion in a case where the bulky banknotes 100 are stored in the storage bag 9.

The third full capacity criterion is that the pusher 5 does not reach the maximum pushing position and the stage 40 reaches the lowest position. The third full capacity criterion is a criterion in a case where the banknote 100 is thick.

In order to determine the full capacity of the banknotes 100, the banknote storage device 2 has a sensor that senses the position of the pusher 5. As shown in FIG. 11 or FIG. 14, the banknote storage device 2 has a first sensor 64, a second sensor 65, a third sensor 66, and a fourth sensor 67. These sensors 64 to 67 may be, for example, optical sensors.

The first sensor 64, the second sensor 65, and the third sensor 66 sense the rotation angle of the drive gear 621 of the gear train 62, thereby sensing the position of the pusher 5. The drive gear 621 has a sensor target 622. The sensor target 622 changes its position in the circumferential direction when the drive gear 621 rotates. The first sensor 64, the second sensor 65, and the third sensor 66 are fixed corresponding to different positions in the circumferential direction of the drive gear 621 on the housing 10 side. The controller 17 determines the position of the pusher 5 based on the sensor having sensed the sensor target 622.

As shown in the view on the left side in FIG. 16, the first sensor 64 corresponds to the standby position of the pusher 5. While banknotes are accumulated on the pair of plates 71, the pusher 5 is positioned at the standby position.

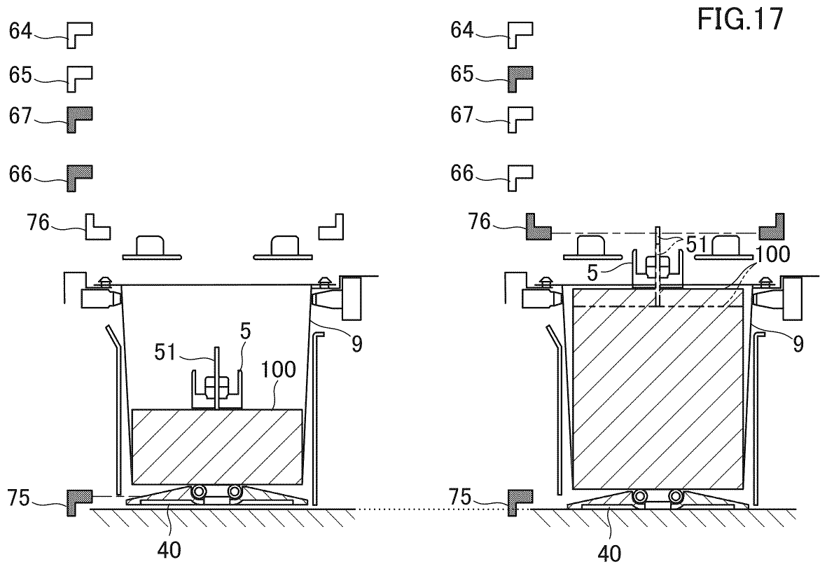

As shown in a view on the right side in FIG. 17, the second sensor 65 corresponds to the position of the pusher 5, that is, an upper end sensing position, when the position of the end of the stack of banknotes stored in the storage bag 9 is sensed.

As shown in a view on the right side in FIG. 16 or a view on the left side in FIG. 17, the third sensor 66 corresponds to a maximum push-in position of the pusher 5. In other words, the maximum push-in position is the lowermost end in the Z-direction, which can be reached by the pusher 5.

The fourth sensor 67 senses the angle of a link of the link mechanism 63, thereby sensing the position of the pusher 5. As shown in FIG. 11, the fourth sensor 67 senses a link target 631 provided for the link. When the link reaches a predetermined angle, the fourth sensor 67 can sense the link target 631.

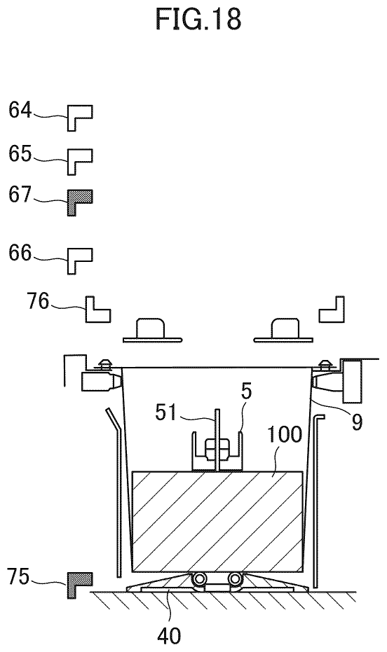

As shown in the view on the right side in FIG. 16, the view on the left side in FIG. 17, or FIG. 18, the fourth sensor 67 corresponds to a push-in securing position of the pusher 5. The push-in securing position of the pusher 5 is between the upper end sensing position and the maximum push-in position. When the pusher 5 performs the push-in operation, the controller 17 determines, based on sensing of the fourth sensor 67, that the push-in operation of the pusher 5 by the drive mechanism 6 is normally performed.

The banknote storage device 2 further has a stage sensor 75 that senses the position of the stage 40. As shown in the view on the left side in FIG. 17, the stage sensor 75 senses that the stage 40 reaches the lowest position. The stage sensor 75 may be, for example, an optical sensor.

The banknote storage device 2 further has a full capacity position sensor 76 that senses that the end of the stack of the banknotes 100 stored in the storage bag 9 reaches the full capacity position. The full capacity position sensor 76 is an optical sensor, and senses light transmission and light blocking. As shown in the view on the right side in FIG. 17, the full capacity position sensor 76 senses, in a state of the second sensor 65 having sensed the sensor target 622, that a light blocking plate 51 blocks light.

As shown in FIG. 11, the light blocking plate 51 is turnably attached to the pusher 5. The light blocking plate 51 displaces between a first position (see a chain double-dashed line) at which the light blocking plate 51 protrudes downward of the lower surface of the pusher 5 and a second position (see a solid line or a dashed line) at which in a state in which the lower surface of the pusher 5 contacts the end of the stack of the banknotes 100 stacked on each other, the light blocking plate 51 is pushed by the banknote 100 and turns upward.

When the light blocking plate 51 is at the second position, the light blocking plate 51 closes an optical window 52 provided for the pusher 5. The optical window 52 is a window through which the optical axis of the full capacity position sensor 76 passes in a state of the second sensor 65 having sensed the sensor target 622. Thus, in a state of the second sensor 65 having sensed the sensor target 622, that is, in a state of the pusher 5 being at the predetermined position shown in the view on the right side in FIG. 17, when the lower surface of the pusher 5 contacts the end of the stack of the banknotes 100 stacked on each other, the light blocking plate 51 is lifted to the second position. Thus, the full capacity position sensor 76 is blocked from light. The banknote storage device 2 can sense that the end of the stack of the banknotes 100 reaches the full capacity position.

As indicated by a chain double-dashed line in the view on the right side in FIG. 17, when the end of the stack of the banknotes 100 is apart from the lower surface of the pusher 5, the light blocking plate 51 is lowered to the first position. Thus, light is transmitted through the full capacity position sensor 76. The banknote storage device 2 can sense that the end of the stack of the banknotes 100 does not reach the full capacity position.

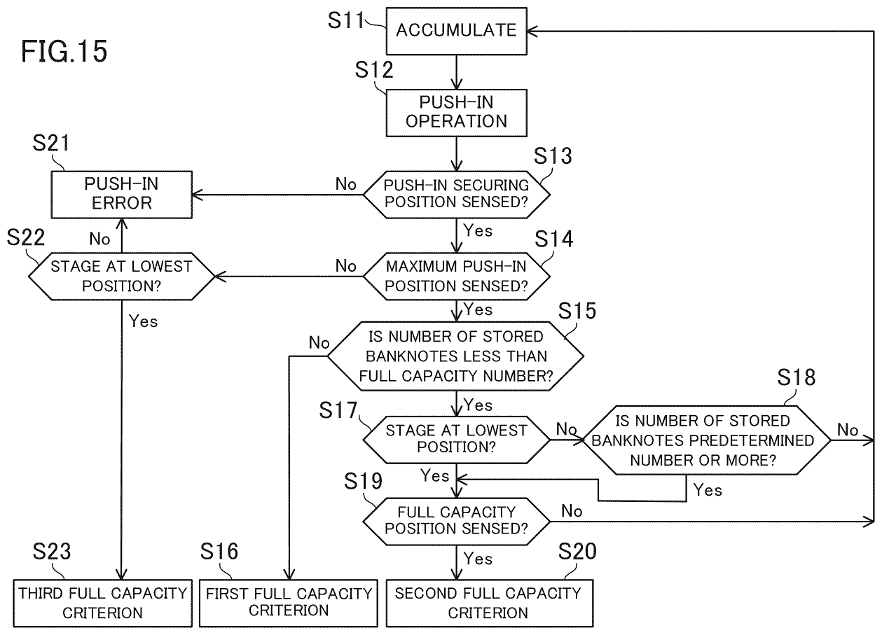

FIG. 15 is a flowchart regarding determination on the full capacity of the storage bag 9 in the banknote storage device 2. First, in Step S11, the banknotes 100 are accumulated on the pair of plates 71 (see the view on the left side in FIG. 16). When a predetermined number of banknotes 100 is accumulated on the pair of plates 71, the pusher 5 executes the operation of pushing in the banknotes 100 subsequently in Step S12.

In Step S13, the banknote storage device 2 determines whether or not the second sensor 65 senses passage through the push-in securing position. If not, the banknote storage device 2 determines, in Step S21, that a push-in error is caused. Due to the error, the flow of FIG. 15 ends.

If passage through the push-in securing position is sensed, the banknote storage device 2 determines, in Step S14, whether or not the third sensor 66 senses the maximum push-in position.

If sensed, the pusher 5 reaches the maximum push-in position as shown in the view on the right side in FIG. 16. Subsequently in Step S15, the banknote storage device 2 determines whether or not the number of banknotes 100 stored in the storage bag 9 is less than the preset full capacity number. The number of banknotes 100 stored in the storage bag 9 is counted by the controller 17 as described above. In Step S15, if the number of stored banknotes 100 is not less than the full capacity number, that is, reaches the full capacity number, the banknote storage device 2 determines, in Step S16, that the banknotes stored in the storage bag 9 reach the full capacity, according to the first full capacity criterion.

If it is determined in Step S15 that the number is less than the full capacity number, the banknote storage device 2 determines, in Step S17, whether or not the stage 40 reaches the lowest position, based on sensing by the stage sensor 75 (see the view on the left side in FIG. 17). The stage 40 lowers according to the number of banknotes 100 stored in the storage bag 9.

If the stage 40 does not reach the lowest position, the banknote storage device 2 determines, in Step S18, whether or not the number of stored banknotes is a predetermined number or more. This predetermined number is a number less than the full capacity number. If the number of stored banknotes is less than the predetermined number, the banknotes 100 can be further stored in the storage bag 9, and therefore, the process of FIG. 15 returns to Step S11.

If the number of stored banknotes is the predetermined number or more, the banknote storage device 2 determines, in Step S19, whether or not the end of the stack of the stored banknotes 100 reaches the full capacity position. Specifically, the pusher 5 is positioned at the position sensed by the second sensor 65, and it is determined whether or not the full capacity position sensor 76 is blocked from light (see the view on the right side in FIG. 17).

If the end of the stack of the banknotes does not reach the full capacity position, the banknotes 100 can be further stored in the storage bag 9, and therefore, the process of FIG. 15 returns to Step S11.

If the end of the stack of the banknotes 100 reaches the full capacity position, the banknote storage device 2 determines, in Step S20, that the banknotes 100 stored in the storage bag 9 reach the full capacity, according to the second full capacity criterion.

Returning to Step S14, if the maximum push-in position is not sensed, the process of FIG. 15 transitions to Step S22. Based on sensing by the stage sensor 75, the banknote storage device 2 determines whether or not the stage 40 is at the lowest position. If the stage 40 is not at the lowest position, the banknote storage device 2 determines, in Step S21, that the push-in error is caused.

If the stage 40 is at the lowest position, the banknote storage device 2 determines, in Step S23, the banknotes 100 stored in the storage bag 9 reach the full capacity, according to the third full capacity criterion.

Here, if the drive mechanism 6 moves the pusher 5 to the maximum push-in position, the position of the end of the stack of the banknotes 100 stacked on each other in the storage bag 9 is different between a case of the first full capacity criterion being satisfied (that is, case A), a case of the second full capacity criterion being satisfied (that is, case B), and a case of the third full capacity criterion being satisfied (that is, case C), as shown in FIG. 14. The drive mechanism 6 has a torque limiter 623 for absorbing the difference in the position of the end of the stack.

As shown in FIG. 11, the torque limiter 623 is provided for the gear train 62 of the drive mechanism 6. In the case B or the case C of FIG. 14, the torque limiter 623 slides, and accordingly, the pusher 5 can be stopped at a high position in the Z-direction. In a case where reaction from the accumulated banknotes is great, the pusher 5 can be stopped at a higher position than that in a case where the reaction from the accumulated banknotes is small.

In the case A and the case B, the third sensor 66 can sense the sensor target 622. The determination in Step S14 in the flow of FIG. 15 is Yes. In the case C, the third sensor 66 cannot sense the sensor target 622. The determination in Step S14 in the flow of FIG. 15 is No.

(Structure of Reducing Load on Storage Bag upon Lowering of Stage)

When the pusher 5 pushes the banknotes 100 into the storage bag 9, the stage 40 is pushed and lowered by the pusher 5. At this time, the storage bag 9 inserted into the slit 401 of the stage 40 is fed out upward. The storage bag 9 is sandwiched between the banknotes 100 pushed by the pusher 5 and the upper surface of the stage 40, and therefore, if the storage bag 9 is not smoothly fed out, a load on the storage bag 9 increases and may stretch the storage bag 9 or fall apart the banknotes 100 stacked on each other in the storage bag 9.

FIG. 19 shows the stage 40 in closeup. A view on the left side in FIG. 19 is a sectional view of the stage 40 taken along a Y-Z plane, and a view on the right side is a view of the stage 40 from the side opposite to that of the view on the left side.

The stage 40 has a feeding mechanism 8. The feeding mechanism 8 reduces the feeding resistance of the storage bag 9.

The feeding mechanism 8 has a feeding roller 80. The feeding roller 80 extends in the X-direction along the edge of the slit 401 (also see FIG. 4). The feeding roller 80 contacts the storage bag 9 inserted into the slit 401. The feeding roller 80 can rotate about an axis extending in the X-direction. The feeding mechanism 8 has two feeding rollers 80 spaced apart from each other in the Y-direction.

The feeding mechanism 8 has a rack 81. The feeding mechanism 8 has two racks 81 corresponding to the two feeding rollers 80. One rack 81 is position on one side with respect to the stage 40 in the Y-direction, and the other rack 81 is positioned on the other side with respect to the stage 40. Teeth of the rack 81 are arranged in the Z-direction. The rack 81 is fixed to the first base 41.

The feeding mechanism 8 has a pinion 82 engaged with the rack 81. The pinion 82 is also engaged with a gear fixed to the feeding roller 80. The pinion 82 is rotatably supported by the stage 40. When the stage 40 is pushed by the pusher 5 and lowered relative to the first base 41, the pinion 82 is engaged with the rack 81 while rotating in a direction indicated by an arrow in FIG. 19. Along with rotation of the pinion 82, the feeding roller 80 rotates in the direction opposite to that of the pinion 82. Each feeding roller 80 rotates in a direction of feeding the storage bag 9 out of the slit 401.

The feeding mechanism 8 has two synchronous gears 83. The synchronous gear 83 is engaged with the gear of each of the two feeding rollers 80, and the synchronous gears 83 are also engaged with each other. With the synchronous gears 83, rotations of the two pinions 82 are synchronized with each other, and therefore, it is secured that the stage 40 lowers while maintaining its horizontal state.

When the stage 40 lowers, each of the two feeding rollers 80 rotates in a direction of feeding out the storage bag 9, as indicated by an arrow in FIG. 19. The feeding resistance of the storage bag 9 is reduced, and therefore, stretching of the storage bag 9 can be reduced and the banknotes 100 can be stably stacked on each other in the storage bag 9.

### (Structure of Stably Sealing Bag Mouth of Storage Bag)

Not only the banknote storage device 2 is compact, but also the banknote storage device 2 has the amount of storage in the storage bag 9 as great as possible. Reduction in the height difference H between the end of the stack of the banknotes 100 stored in the storage bag 9 and the heater 31 and the receiving unit 32 is advantageous in increasing the storage amount. Not only the banknote storage device 2 has the height difference H as small as possible, but also the banknote storage device 2 is designed to prevent banknotes from being caught by the bag opening 90 when the bag opening 90 is sealed by the sealing mechanism 3.

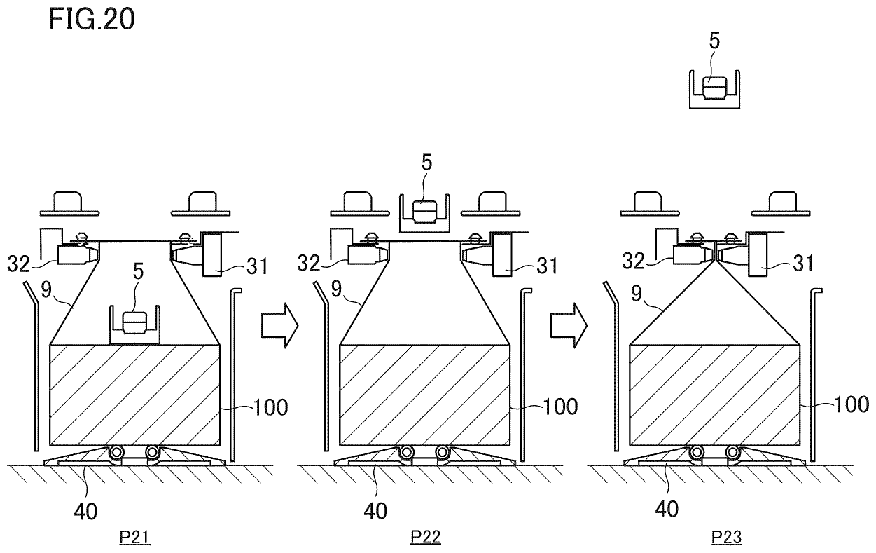

Specifically, as shown in Step P21 of FIG. 20, in a state of the pusher 5 pushing the banknotes 100 into the storage bag 9, the sealing mechanism 3 starts a sealing operation. That is, the first holder 21 and the second holder 22 approach each other, and accordingly, the heater 31 and the receiving unit 32 approach each other in the Y-direction. After the start of the sealing operation, the pusher 5 retracts outward of the storage bag 9, as shown in Step P22. After retracting of the pusher 5, the heater 31 and the receiving unit 32 seal the bag opening 90 of the storage bag 9, as shown in Step P23.

When the banknote storage device 2 determines, based on the second full capacity criterion, that the storage bag 9 reaches the full capacity, the banknote storage device 2 may seal the bag opening 90 of the storage bag 9 in steps shown in FIG. 20. This is because the second full capacity criterion has a high probability of the stacked banknotes 100 expanding and being caught by the bag opening 90.

Unlike FIG. 20, when the banknote storage device 2 determines, based on the first full capacity criterion or the third full capacity criterion, that the storage bag 9 reaches the full capacity, the pusher 5 may retract outward of the storage bag 9, and thereafter, the sealing mechanism 3 may start the sealing operation of sealing the bag opening 90.

Here, when the pusher 5 pushing in the banknotes 100 is released from the banknotes 100, the uppermost banknote 100 may be taken together with the pusher 5 and be caught by the bag opening 90. The storage bag 9 has a restriction piece 95 that restricts protrusion of the banknote 100.

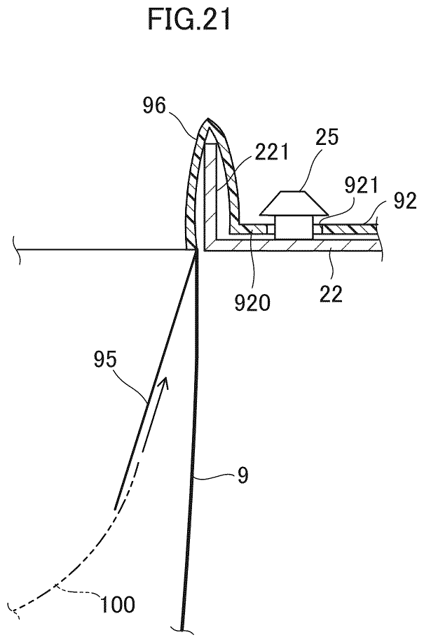

As shown in FIG. 3, the restriction piece 95 is attached to each of the first edge 91 and second edge 92 of the bag opening 90 so as to extend in the X-direction. As shown in the section of the bag opening 90 in FIG. 21, the restriction piece 95 extends downward and inward of the first edge 91 or the second edge 92. As indicated by a chain double-dashed line in FIG. 21, the banknote 100 taken together with the pusher 5 is engaged with the restriction piece 95, and in this manner, protrusion of the banknote 100 from the bag opening 90 is restricted.

As shown in FIG. 21, a hard film 96 is attached to the bag opening 90 of the storage bag 9. As shown in FIG. 3, the hard film 96 is attached to each of the first edge 91, the second edge 92, the third edge 93, and the fourth edge 94. The hard film 96 has higher stiffness than that of a body portion of the storage bag 9. With the hard film 96, the bag opening 90 of the storage bag 9 can stably maintain its opened state.

The hard film 96 has a pocket shape opened downward. The edge of the second holder 22 (or the first holder 21) is integrally provided with an upwardly-standing engagement piece 221. The pocket-shaped hard film 96 covers the engagement piece 221. Inward tilting of the hard film 96 is reduced by the engagement piece 221. The bag opening 90 of the storage bag 9 can stably maintain its opened state. When the bag opening 90 is sealed and the first holder 21 and the second holder 22 approach each other, the hard film 96 does not tilt. The first edge 91 and the second edge 92 stably contact each other, and therefore, the sealing mechanism 3 can stably seal the bag opening 90.

Note that the banknote storage device 2 does not necessarily stack the banknotes 100 up and down. The banknote storage device 2 may accumulate the banknotes 100 in the horizontal direction, and the pusher 5 may push the banknotes 100 in the horizontal direction to store the banknotes 100 in the storage bag 9.

What is claimed is:

1. A money storage device comprising:
a pair of plates having accumulation surfaces on which banknotes are accumulated in a support posture in which the pair of plates is arranged in a first direction; and
a pusher that pushes the banknotes accumulated on the accumulation surfaces in a second direction crossing the first direction, to store the banknotes in a storage bag,
wherein the pair of plates changes from the support posture to a passage posture, and
the banknotes pushed by the pusher are guided by the accumulation surfaces of the pair of plates in the passage posture while passing between the pair of plates, and are stored in the storage bag.

2. The money storage device of claim 1, wherein
an interval in the first direction between the pair of plates in the passage posture is narrower than a width of the banknote in the first direction.

3. The money storage device of claim 1, wherein
each of the pair of plates is pivotally supported by a pivot shaft orthogonal to the first direction and the second direction, and turns in the second direction from the support posture to change to the passage posture, and
an interval between the pivot shafts is narrower than the width of the banknote in the first direction.

4. The money storage device of claim 3, wherein
an angle of each of the pair of plates in the passage posture with respect to that in the support posture is 80° or less.

5. The money storage device of claim 1, wherein
the banknotes passing between the pair of plates are sandwiched by the pusher and the pair of plates and are bent in the second direction.

6. The money storage device of claim 1, further comprising:
a stage positioned on an opposite side of the pair of plates from the pusher and supporting the banknotes stored in the storage bag,
wherein the stage holds the banknotes between the stage and the pusher when the pusher pushes the banknotes.

7. The money storage device of claim 6, wherein
the stage moves in the second direction between a first position at which the stage approaches the pair of plates and a second position at which the stage is apart from the pair of plates, according to a number of the banknotes stored in the storage bag.

8. The money storage device of claim 7, further comprising:
a movement mechanism that moves the stage,
wherein the movement mechanism has a first base supporting the stage such that the stage is movable in the second direction and a second base supporting the first base such that the first base is movable in the second direction.

9. The money storage device of claim 8, wherein
the movement mechanism has a belt supported by the first base and wound around a pair of pulleys,
the stage is engaged with a first carriage fixed to the belt, and
the second base is engaged with a second carriage fixed to the belt.

10. The money storage device of claim 1, further comprising:
a controller that determines, based on a first full capacity criterion or a second full capacity criterion, a full capacity of the banknotes stored in the storage bag,
wherein the first full capacity criterion is that the number of banknotes stored in the storage bag reaches a full capacity number, and
the second full capacity criterion is that the number of banknotes stored in the storage bag is less than the full capacity number and an end of a stack of the banknotes stacked in the storage bag reaches a full capacity position.

11. The money storage device of claim 10, further comprising:
a sensor that senses that the pusher performing a push-in operation reaches a maximum push-in position,
wherein when the stage supporting the banknotes stored in the storage bag and displacing according to the amount of the banknotes reaches a lowest position and the sensor senses that the pusher reaches the maximum push-in position, the controller determines, based on the first full capacity criterion or the second full capacity criterion, the full capacity of the banknotes stored in the storage bag.

12. The money storage device of claim 11, wherein
the controller further determines the full capacity of the banknotes stored in the storage bag based on a third full capacity criterion that the stage reaches the lowest position and the sensor does not sense that the pusher reaches the maximum push-in position.

13. The money storage device of claim 10, further comprising:
a sealing mechanism that seals a bag opening of the storage bag,
wherein the sealing mechanism starts a sealing operation in a state of the pusher pushing the banknotes, and after the start of the sealing operation, the pusher retracts outward of the storage bag, and
a position of the pusher at the start of the sealing operation is different between a case where the full capacity is determined based on the first full capacity criterion and a case where the full capacity is determined based on the second full capacity criterion.

14. A money handling device comprising:
a depositing unit; and
a money storage device that stores banknotes fed out of the depositing unit,
wherein the money storage device includes a pair of plates having accumulation surfaces on which the banknotes are accumulated in a support posture in which the pair of plates is arranged in a first direction, and
a pusher that pushes the banknotes accumulated on the accumulation surfaces in a second direction crossing the first direction, to store the banknotes in a storage bag,
the banknotes pushed by the pusher pass between the pair of plates changed from the support posture to a passage posture, and are stored in the storage bag, and
an interval in the first direction between the pair of plates in the passage posture is narrower than a width of the banknote in the first direction.

15. A money storage method comprising:
accumulating banknotes on accumulation surfaces of a pair of plates in a support posture;
pushing, by a pusher, the banknotes accumulated on the accumulation surfaces toward a storage bag, and changing the pair of plates from the support posture to a passage posture;
guiding the banknotes pushed by the pusher by the accumulation surfaces of the pair of plates in the passage posture; and
causing the banknotes to pass between the pair of plates, and storing the banknotes in t he storage bag.
